(19) United States
(12) Patent Application Publication
(10) Pub. No.: US 2014/0257938 A1
(43) Pub. Date: Sep. 11, 2014

(54) SYSTEM AND METHOD FOR ANALYZING HOSPITALITY INDUSTRY DATA AND PROVIDING ANALYTICAL PERFORMANCE MANAGEMENT TOOLS

(71) Applicant: KALIBRI LABS, LLC, Southlake, TX (US)

(72) Inventors: Cindy Estis GREEN, Potomac, MD (US); Robert S. BENNETT, Southlake, TX (US)

(73) Assignee: KALIBRI LABS, LLC, Southlake, TX (US)

(21) Appl. No.: 14/204,854

(22) Filed: Mar. 11, 2014

Related U.S. Application Data
(60) Provisional application No. 61/776,707, filed on Mar. 11, 2013.
(60) Provisional application No. 61/777,451, filed on Mar. 12, 2013.

(51) Int. Cl. G06Q 50/12; G06Q 10/06

(52) U.S. Cl. CPC G06Q 50/12; G06Q 10/0639
USPC 705/7.38

(57) ABSTRACT

Hospitality customer acquisition and retention costs are analyzed on a per-channel, channel-agnostic, and aggregated basis. Hotel performance is analyzed by examining net revenue by channel (accounting for each channel's contribution to operating expenses and profits), net revenue in aggregate (via net revPAR and revPAR capture metrics), and the relative benefit of sales and marketing expenses by quantifying net sales and marketing efficiency. Conceptually, this differentiation parses the relevant business into a revenue performance evaluation and a return on investment evaluation, in terms that are specific to the hospitality environment. Transaction data is analyzed from multiple hotels and each hotel's costs are mapped to a common data structure to allow for hotel-to-industry comparisons. Graphical user interfaces are provided for reporting data and comparisons, and for receiving input to initiate what-if analyses to determine projected impacts to performance metrics as a result of changes made to business mix components.

### CROSS-REFERENCE TO RELATED APPLICATIONS

This application is based on, and claims priority to, U.S. Provisional Patent Application Nos. 61/776,707, filed Mar. 11, 2013, and 61/777,451, filed Mar. 12, 2013, the entire contents of both of which are fully incorporated herein by reference.

### FIELD OF THE INVENTION

The present invention relates generally to analysis of data in the hospitality industry, and more particularly to a system and method for analyzing hospitality industry data for the purposes of increasing profitability.

### DISCUSSION OF RELATED ART

The hospitality industry is highly segmented, with relatively little centralized control and relatively little business intelligence useful for managing profitability. For example, in the hotel segment alone, there are many different hotel chains/brands, such as Marriott, Hilton, IHG and Hyatt, each of which operates according to a structure by which they provide marketing and other services to a hotel owner and, in addition, the brand either manages the hotel for the owner or the owner pays the brand a franchise fee and hires another company to manage the hotel for them. Brands provide marketing support, operational standards and a known name/affiliation for the hotel. Whoever manages the hotel, either the brand or a third party management company is responsible to deliver an agreed profit out from the business. The owner of the hotel will supervise the management team and often has an asset manager responsible for this function. The data and analytics that are available for a hotel management team, an asset manager and/or owner to evaluate the overall process of generating revenue is limited in scope. Further to this, each brand has its own proprietary system for identifying customer types, reporting business production and evaluating profitability by each type of business. For many owners, they have to learn proprietary systems for each brand and that makes the tools for business evaluation and oversight of the brand's performance inconsistent and confusing. For the benefit of the brands' own self-evaluation and for the owners comparing multiple brands, there is an imperative to develop a range of metrics that allow a brand, management team or hotel owner to fully evaluate profit potential for all types of customer segments in terms of production, source of business, and many other variables that have previously not existed in the hotel industry except one high level revenue metric called revenue per available room. Anything more granular than this metric has not been possible on an industry-wide basis.

In the context of the hotel segment of the hospitality industry each hotel/franchisee has its own computerized system that records and stores all of the data for guests in connection with their reservations, check-in and checkout, and various on-property purchases, including all payment-related information. Most hotels' systems transmit this data via a communications network to a central accounting or corporate office of an associated brand/franchisor for reporting, storage and/or reference purposes. However, very little if any analysis and/or reporting of this data is made for the purpose of improving any individual hotel's/franchisee's profitability. Accordingly, despite a relatively large data set, an individual hotel/franchisee has very little data-based business intelligence to assist the individual hotel/franchisee in making sales and marketing decisions that could improve profitability on a per-hotel/franchisee basis.

What is needed is a system and method for analyzing hospitality industry data that allows for standardization for cross-brand comparisons and benchmarking purposes, an in-depth view of market and/or channel segmentation and related costs and profitability, and tools for improving and/or optimizing performance on a per-hotel and/or per-owner basis.

### SUMMARY

The inventive system enables evaluation of a hotel's total aggregate revenue performance (net RevPAR metric) and then breaks out the two primary ways that this revenue is acquired, namely: (1) using channel-specific levers such a commissions, transaction fees, channel technology, booking incentives (as reflected in the COPE % metric); and (2) using non-channel specific levers, such as broadly spent sales and marketing funds like generalized media, sales payroll, public relations and social media (as reflected in a Sales & Marketing Efficiency metric). This process allows hotel management to look at a macro view and then to take micro-snapshots to identify those elements that are cost-effective and those that are not. The analytics process further unpacks the efficacy of various customer acquisition methods (via different marketing channels) by filtering these three main metrics to be viewed by the variables that more finely parse the customers acquired into subgroups that reveal more about the nature of specific booking profiles, such as by stay day of week, length of stay, booking lead time, specific travel agency account or type of travel agency account.

The system examines hospitality customer acquisition and retention costs and determines which ones can be applied by marketing channel, and which ones are diffused across multiple channels and therefore should be analyzed in aggregate against total revenue (all channels combined). The metrics are designed to enable an analytics methodology that examines hotel, etc. performance in absolute terms at a micro level and macro level by examining (1) net revenue by channel (COPE %)—micro level, (2) net revenue in aggregate (net revPAR and revPAR capture)—macro level, and (3) the relative benefit of the sales and marketing investment by examining the net sales and marketing efficiency (net revenue generated for every $1 spent in sales/marketing). This evaluation is enabled by differentiating channel-specific costs from diffused costs and treating them differently. Conceptually, this differentiation parses the relevant business into a revenue performance evaluation and a return on investment evaluation, in terms that are specific to the hospitality environment. As a result, a systematic review of the performance of hotels, etc. vis-à-vis its revenue generation function is provided.

Accordingly, the inventive system and method accounts for both transactional and sales/marketing costs that are typically scattered across various operations and sales/marketing accounts and combines them for evaluation in a holistic manner. In particular, the inventive system is capable of capturing such costs from the many disparate places in which they appear, and of capturing even those costs that do not appear on a financial statement. The objective is to determine the highest and best use of acquisition and retention resources by identifying the most profitable sub-sets of business, and to enable the setting of priorities that are aligned with the opportunities in any given market at any given time. By offering cuts of this data in any combination to the user, they can test many variations easily, with graphical illustrations, to quickly identify the optimal combination of business types or accounts that are most productive.

More specifically, the characterization of the various customer types and booking behaviors (e.g. channels, segments, sub-segments, booking lead time, length of stay et. al.) is normalized to ensure that users of the system will see comparable information in regardless of market, hotel type, or hotel brand. Further, the costs are normalized as well to ensure comparability regardless of market, hotel brand, hotel type or geographic location.

The inventive system combines normalization along with the comprehensive application of essentially all acquisition and retention costs (including those in the P&L and those not) and creates a systematic sequence of metrics that allows the user to test variables and customer and business categories in many combinations in order to establish the hotel's optimal spending and revenue objectives.

The data processing methodology and graphic views of the metrics are integrated into Opportunity Matrix and Channel Optimizer graphical user interfaces. Hotel-specific data is combined into an industry-wide database to provide benchmarking capability for comparing one hotel, etc. to comparable hotels, etc.

### BRIEF DESCRIPTION OF THE FIGURES

An understanding of the following description will be facilitated by reference to the attached drawings, in which:

FIG. 1 is a flow diagram of a method for analyzing hospitality industry data using predictive analytics in accordance with an exemplary embodiment of the present invention;

FIGS. 2A-2E are images of exemplary graphical user interface windows for performing predictive analytics in accordance with an exemplary embodiment of the present invention;

FIG. 3 is an image of an alternative graphical user interface window showing user interface controls for performing predictive analytics in accordance with an alternative embodiment of the present invention;

FIG. 4 is a flow diagram of a method for normalizing hospitality industry data transaction records in accordance with an exemplary embodiment of the present invention;

FIG. 5 is an image of a representation of exemplary hospitality industry data;

FIG. 6 is an image of a representation of a conversion table for normalizing data according to the method of FIG. 4, prepared in accordance with an exemplary embodiment of the present invention;

FIG. 7 is a flow diagram of a method for performing comparative analysis of hospitality industry data to identify marketing in accordance with another exemplary embodiment of the present invention;

FIG. 8 is an image of an exemplary graphical user interface window displaying a graphical representation of geography-based marketing opportunities in accordance with the method of FIG. 7;

FIG. 9 is a schematic of an exemplary system for analyzing hospitality industry data and providing tools for managing performance; and

FIG. 10 is a block diagram showing an exemplary networked computing environment in which a system and method in accordance with the present invention may be practiced.

### DETAILED DESCRIPTION

The present invention relates to a system and method for analyzing hospitality industry data that provides tools for improving and/or optimizing performance on a per-hotel and/or per-owner basis or across a range of hotels managed and/or owned by one company that may be representing multiple brands.

As discussed above, the inventive system enables evaluation of the hotel's total aggregate revenue performance (net RevPAR metric) and then breaks out the two primary ways that this revenue is acquired, namely: (1) using channel-specific cost levers, such as commissions, transaction fees, channel technology, booking incentives (as reflected in the COPE % metric); and (2) using non-channel specific cost levers, such as broadly spent sales and marketing funds like generalized media, sales payroll, public relations and social media (as reflected in the Sales & Marketing Efficiency metric). This process allows management to look at the macro view and then to take micro-snapshots to identify those elements that are cost-effective and those that are not.

Hotel transaction data is originally recorded and/or organized in non-uniform fashions. After normalization disparate data from disparate hotels can be compared and manipulated in advantageous fashion. By way of overview, the system starts the analytical process by aggregating normalized hotel transaction data to result in hotel revenue and room nights organized by according to various codes of a common data structure. This allows for categorization of business activities/components by meaningful groupings that are primarily marketing channels that represent the path through which each consumer passed to make a hotel booking, sub-channels to illustrate who made the booking, segments to indicate the trip purpose of the traveler, sub-segments to reflect the rate type paid by the traveler and accounts that booked the business like travel agents or online travel agencies.

The system then filters the hotel production by booking behavior, such as how far in advance a booking was made (lead time), how long a traveler stayed in a hotel (length of stay), what days they stayed, what months they stayed, what type of room they stayed in, whether they booked a package or a room only et.al.

The system then collects and organizes the costs associated with acquiring and retaining customers. The costs are usually associated with the channels and sub-channels, so the system applies costs in a normalized manner so it is done the same for each hotel, even though every hotel/company has substantially different ways of recording the codes and the costs. The segment and the sub-segment codes provide the details on the channels to ensure the correct costs are applied to each transaction. They are part of the business rules used to standardize across all companies.

After transactions are coded and costs are applied, then the business performance is aggregated to reflect the revenue by channel. The costs that are directly connected to each transaction are also aggregated and deducted from the revenue to illustrate the hotel's channel-specific net revenue, and the exact amount of cost associated with each corresponding channel.

This channel-specific analysis can be further filtered to show subsets of each channel that are either included or excluded from the total—such as segments, sub-segments and any differences in net revenue by the variables of booking profile such as lead time, length of stay, stay day of week or by individual booking agent.

How each channel performed in delivering bookings to the hotel can then be evaluated. After the channel-specific analysis is complete, the total revenue is aggregated to show how well a hotel performed overall on the basis of revenue per available room. This is the sum total of all revenue (room revenue or total revenue) and is shown to reflect Gross RevPAR which includes the commissions collected from the customer by a third party wholesaler (but not reflected on the hotel's profit and loss records (“P&L”)), P&L RevPAR including just the revenue on the P&L (not including the part the customer paid to the third party wholesaler), Net RevPAR (net res) showing the channel-specific costs deducted from the P&L Revenue and Net RevPAR (net bacq) showing the channel-specific costs PLUS all other sales and marketing expenses which combined represent the hotel's total acquisition and retention cost deducted from the P&L Revenue.

Once the hotel has its two absolute metrics showing actual revenue performance by channel (COPE %) and in aggregate (Net RevPAR), it can look at a relative metric to ascertain how well the hotel spent its funds that were diffused across multiple channels. A Sales and Marketing Efficiency tells hotel management how productive the funds were that were invested across multiple channels (meaning they are not charged directly to a specific transaction or channel). This answers the question of how much revenue was generated for every dollar spent in sales and marketing. The hotel's revenue is reflected through COPE % and RevPAR. When benchmarked against other hotels, these metric indicate whether the revenues are more or less than others produced in the same market. The efficiency reveals whether the broadly-applied sales and marketing costs were relatively more or less productive than other hotels in the same or similar market conditions.

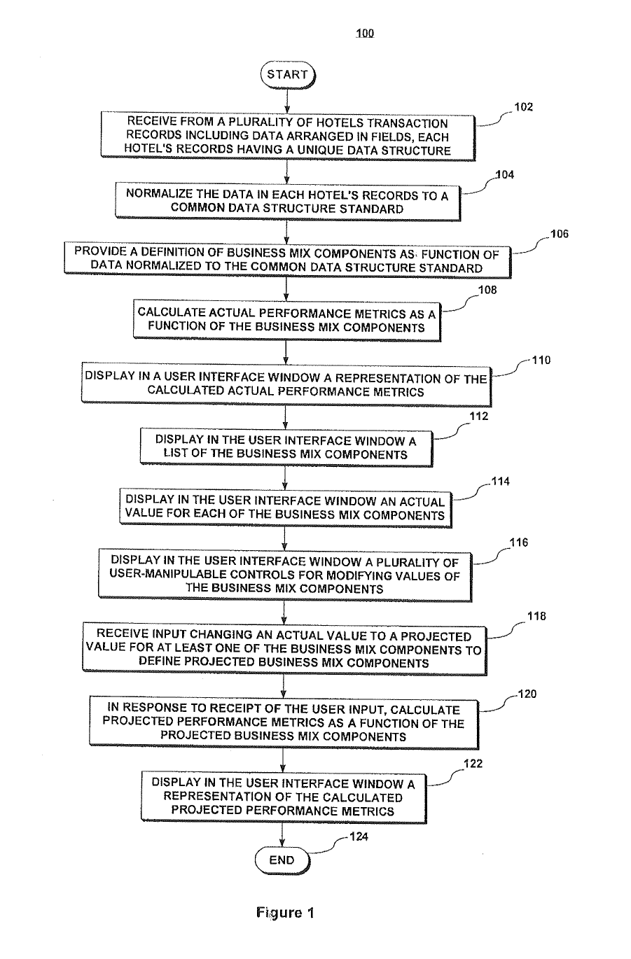

In accordance with one aspect of the present invention, a method for analyzing hospitality industry data using predictive analytics is discussed below. A flow diagram 100 illustrating an exemplary method with respect to hotel industry data, the term “hotel” being used broadly and in a non-limiting fashion, is shown in FIG. 1. It should be appreciated that the references to hotel industry data is illustrative only and not limiting. As will be appreciated by those skilled in the art, other data in the hospitality industry, and data from other industries, may be analyzed in a similar manner in accordance with the present invention.

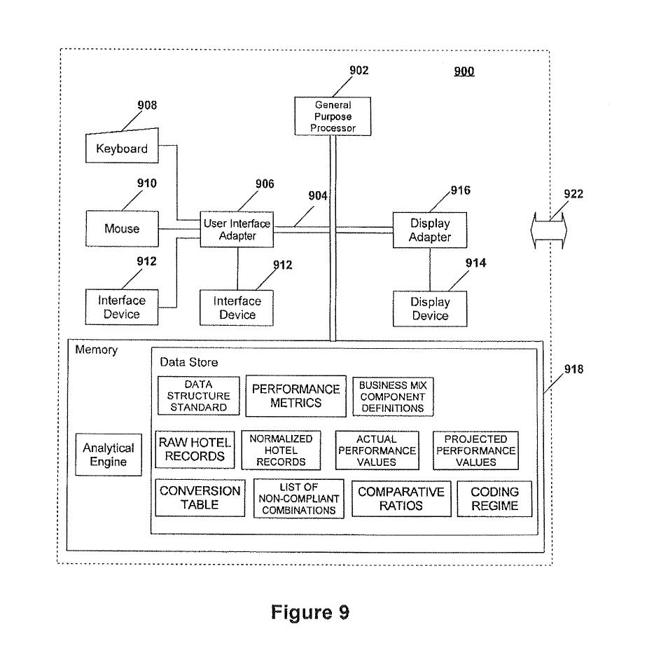

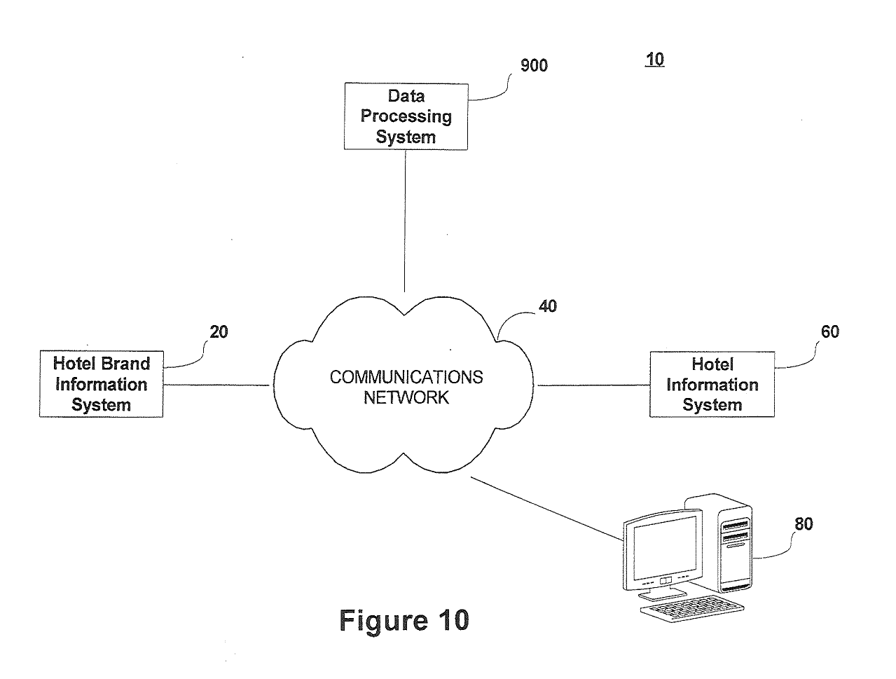

The exemplary methods described herein are implemented by a computerized Data Processing System (DPS 900) in accordance with the present invention. As will be appreciated by those skilled in the art, and as discussed in greater detail in reference to FIG. 9 below, the DPS may be configured as a computing device in a cloud-based computing environment, server in a client/server computing environment, or as a client device or as a stand-alone workstation. Any suitable computing environment may be used. Key characteristics may include 1) having the ability to connect over the internet to the data systems of the various brand companies and individual hotels for the purpose of obtaining the source data, 2) the ability to store large quantities of data, 3) the ability to process the routines which validate, edit, transform and normalize the hotel data received 4) the ability to store the normalized data into a data warehouse model which supports the required analytics through coding, indexing, aggregation, and other typical warehouse techniques and 5) the ability for hotel customers/users to access the analytics produced by the analytics engine via an easy-to-use interface supported by an internet web browser or a mobile device which supports interactive web-based sessions. In an exemplary embodiment, the DPS 900 is configured as a computing device operating in a networked computing environment, and is connected to various sources of information and data via a communications network, as will be appreciated from FIG. 10.

The present invention may be understood with reference to the exemplary simplified network environment 10 of FIG. 10. As shown in FIG. 10, the exemplary networked environment 10 includes a DPS 900 in accordance with the present invention. Notably, each system shown in FIG. 10 is shown logically for illustrative purposes only, without regard to any particular embodiment in one or more hardware or software components. The DPS 900 includes conventional computing hardware but is specially-configured with special-purpose software in accordance with the present invention to provide a particular special-purpose machine configured to carry out one or more aspects of the inventive methods described herein, as discussed in further detail herein.

The exemplary simplified network environment 10 further includes a hotel brand information system 20, which may be any conventional computer system running any conventional software used for general account, reporting and/or management functions. The hotel brand information system 20 may be an internal proprietary system of a corporate headquarters of a major hotel brand/chain, such as Marriott, Starwood, InterContinental, etc. Alternatively, by way of example, it could be a conventional commercially available system, such as a Corporate version of the Property Management system available from Micros Systems, Inc. of Columbia, Md.

Further, the exemplary simplified network environment 10 further includes a hotel information system 20, which may be any conventional computer system running any conventional software used for general accounting, reporting and/or management functions. The hotel information system 60 may be an internal system of a single instance of a hotel/franchisee. By way of example, commercially available systems include systems running Micros Systems Property Management software available from Micros Systems, Inc. of Columbia, Md. The hotel brand information system 20 and hotel information system 60 are operatively interconnected with the data processing system 900 to enable electronic communication and/or data exchange via a communications network 40, such as the Internet. Conventional computing hardware and software for enabling such communication is well known in the art and beyond the scope of the present invention, and thus is not discussed further herein. Further, the hotel information system 60 may communicate directly with the hotel brand information system 20, e.g., to provide folio or other reservation or stay data for routine reporting purposes. Further, the hotel brand information system 20 (or hotel information system 60) may communicate with the DPS 900 to provide transaction records for analysis, as described herein. The hotel information system 60 (or hotel brand information system 20) may further communicate via the communications network with other information sources or systems, such as a global distribution system (GDS), an online travel agency (OTA) system, telephone call center systems, website hosting systems, etc. (not shown).

In this example, the network environment 10 further includes a hotel management computing device 80, such as a web-browsing enabled personal computer connected via the communications network 40 for communication with the DPS 900, e.g., to interact with and receive reports from the DPS 900, e.g., via a cloud computing services model. By way of example, DPS 900 may include a web server providing a website-based interface to client device 80. Such systems are well-known in the art and beyond the scope of the present invention, and thus are not discussed further herein.

Referring now to the illustrative example of FIG. 1, the exemplary method begins with the receipt from a plurality of hotels transaction records including data arranged in fields, as shown at 102. By way of example, these records may be received by the DPS 900 from a hotel brand information system 20 or hotel information system 60 via a communications network 40, such as the internet. As referred to above, such data is generally routinely provided from individual hotel franchisee's systems to the franchisor's system as part of conventional business processes, albeit for purposes unrelated to the analytical methods described herein. Accordingly, this step can be achieved essentially by configuring the DPS to receive or extract, and/or the hotel franchisee's reservation system to send, a conventional data file/data stream to the DPS system 900. Alternatively, such data may be received from the franchisor's information processing system's data warehouse, or alternatively may be received from other data sources/systems.

As will be appreciated by those skilled in the art, the data may arrive in any suitable format. By way of example, the data may arrive in CSV (Comma Separated Values) format, or may be processed from a native format into a CSV format. Further, any suitable transaction records may be received. By way of example, the transaction records may include reservation records and/or folio records of a type typically transmitted from hotel franchisees to franchisors for internal/routine reporting purposes. In a preferred embodiment, the DPS 900 receives transaction records via a daily data feed from either an individual hotel directly or a central corporate office for a group of hotels. This feed contains information reflecting the folios for those rooms that were checked out each day.

As will be recognized by those skilled in the art, each hotel brand/franchise has systems that provide for formatting of the data according to a proprietary data structure that is unique to a single hotel brand/franchise. By way of example, the data of different hotel brands may be formatted with different field names or types and/or use difference descriptors and/or codes as values within those fields.

In addition, there are other external data; examples of external data that is meaningful to match up with the folio data would be (1) booking costs for each type of reservation, (2) total sales and marketing expenses from the hotel's financial statements/records, (3) geo-coding that is tagged to the address in the folio checkout record, (4) future rates that are available for sale in the market of the hotel or (5) social commentary composite scores for each hotel.

Because the transaction records include data from various hotels that are formatted according to different data structures, the method next involves normalizing the data from different hotels to a common data structure standard, as shown at step 104 of FIG. 1. The common data structure provides a categorization and/or classification system for relating values in various fields in various unique data structures to a common standard, so that comparisons may be made. Further, the common data structure allows for grouping and/or differentiation of various fields in various data structures so that the data can be subsequently analyzed in a fashion consistent with analytical objectives. Accordingly, the common data structure introduces and/or imposes nomenclature that can later be used to interpret, aggregate, classify, or otherwise analyze the data, consistent with analytical objectives which may vary from context to context. Since the field and/or value coding between hotels and hotel companies is often different from one to another, the common data structure provides additional coding to map each individual hotel's data to a common data standard, and this standardized coding is added to a database stored by the DPS system 900 (along with data from the received transaction records) in addition to the hotel's existing coding.

By way of example, the normalization may involve review of a hotel's records' hotel codes and mapping of those codes to the appropriate corresponding common data structure standard's codes, such that each transaction is assigned a booking channel, booking sub-channel, market segment and market sub-segment. Further, the travel agency business may be assigned a code to define its commission structure: retail, net or opaque. Retail indicates the commission is paid by the hotel to a vendor after a guest stay, net rate means that the commission is deducted before the inventory is given to the vendor so the rate offered to the vendor is “net of commission” and the vendor marks up the rate and keeps that marked up value which is paid directly to the vendor by the consumer. This is often called the “merchant model.” Opaque is another form of a net rate, and the discount is usually deeper than the usual net rate but the customer is offered this rate and books the room without knowing the brand of the hotel and has to pre-pay (non-refundable) only knowing a general location and quality rating for the hotel that gets booked.

The database may store a combination of the pre-existing data from the data feed along with derived fields that are calculated from the data feed and data that is added from other external sources. Derived fields of data would be based on calculations within the data such as length of stay (departure date minus arrival date), booking lead time (arrival date minus booking date), or it could be conversions from existing data such as taking a date and appending the corresponding arrival and departure days of week (the hotel systems usually have a date, not a day of week) and “flags” in the original data feed (such as whether it is a package purchase—as opposed to a room only—or if the guest is a loyalty club member).

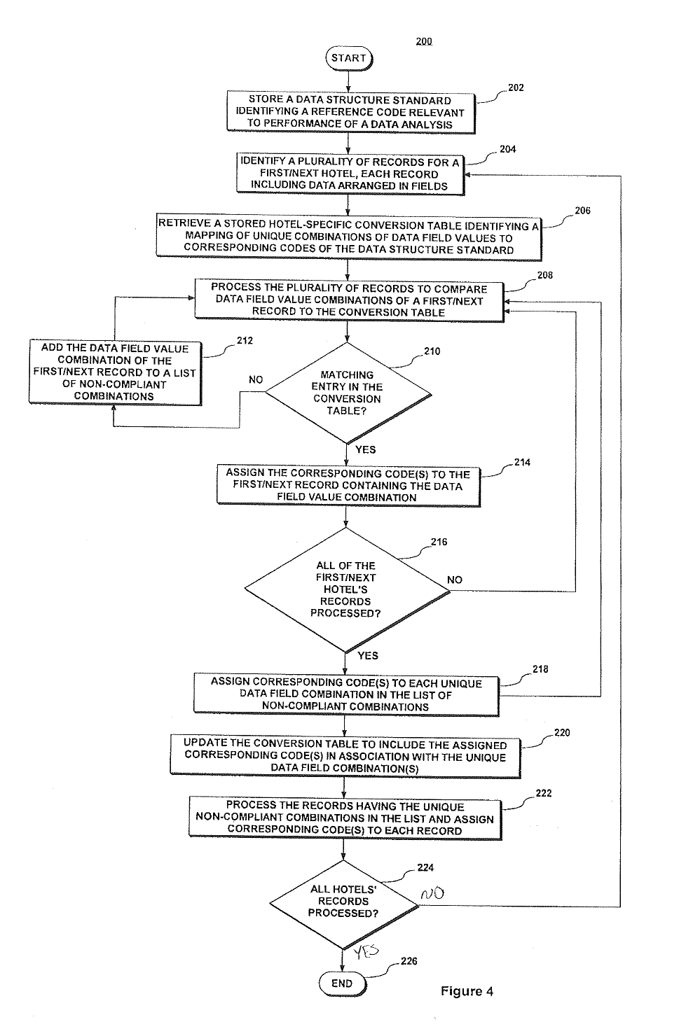

An exemplary method for normalizing such data is shown in FIG. 4 and discussed below. However, alternative methods may be used to normalize the data, and any suitable method may be used.

The system further provides a definition of business mix components as a function of data normalized to the common data structure standard, as shown at step 106. The identification of business mix components may vary and will depend upon the information desired to result from the analysis. By way of illustrative non-limiting example, overall hotel revenue is considered as a function of demand share on a per-channel basis and average daily room rate on a per-channel basis. Accordingly, for an analysis of overall revenue, the business mix components may be demand share (e.g., in room nights (“RN”) and average room rate. In this case, the common data structure would provide a level of granularity suitable for tracking demand share and average room rate on a per-channel basis, and thus may include codes for identifying different channels. Alternatively, a user can evaluate demand share by room nights, revenue or average rate by travel agency, or by market segment or by channel with filters to only show individual guests vs. those attending a meeting. Further, a hotel owner/operator/user can compare one hotel's production at this granular level against that of the other hotels in their area to benchmark their own performance.

Once the database is complete with original data, derived fields of data, common data structure coding and external data, the key performance metrics that measure business performance may be calculated in aggregate, by method of booking, by trip purpose, by the value of each channel or segment net of reservation cost and by rate/product purchased. Examples of these key metrics include (1) total revenue, (2) room revenue, (3) room revenue for every $1 spent in sales and marketing, (4) total revenue for every $1 spent in sales and marketing, (5) room revenue by channel, (6) room revenue by channel net of distribution costs, (7) contribution to profit and operating expense (COPE) as a % of room revenue, (8) revenue per available room, (9) demand share by channel, (10) price index setting the top rate achieved in the prior year at 100 and calculating the position of the subject hotel and its competitors against that benchmark, (11) revenue, demand share and average rate by travel agency.

Next, the exemplary method involves the system's calculation of performance metrics as a function of the business mix components, as shown at step 108. Accordingly, it will be appreciated that the DPS system is configured to store and use definitions of performance metrics as a function of the business mix components. For example, in the context of the revenue example discussed above, the performance metrics may be Net RevPAR (revenue per available room after removal of acquisition costs), Gross RevPAR (revenue per available room paid by customers that includes what the customer paid after adding a wholesaler's markup to the net rate supplied by the hotel) minus net RevPAR (revenue per available room after removal of acquisition and retention costs) with the remainder being the revenue vailable to pay operating expenses and provide a profit to the hotel owner. Another metric is COPE (Contribution to operating expenses and profit) which is room revenue minus channel-specific commissions and transaction fees, Average Daily Rate (ADR) and hotel occupancy.

By way of example, the system's calculation of performance metrics as a function of the business mix components involves examining hotel customer acquisition and retention costs and evaluating which ones can be applied by channel and which ones are diffused across multiple channels, and therefore should be analyzed in aggregate against total revenue (all channels combined). So, for a single hotel, room revenue, total revenue and the acquisition and retention (channel-specific costs plus sales/marketing costs) costs may be mapping to a common data structure to reflect the booking, the customer type, the rate booked, and all costs associated with that booking, customer or rate type. Then, a first subset of the acquisition and retention costs are identified—namely, those that are associated specifically with each channel of a plurality of marketing channels (such as brand.com, GDS, OTA, voice, and property direct channels) because each cost is charged in direct connection with a specific transaction through the specifically identifiable marketing channel. This may be performed using a combination of codes identifying costs types (specified by the common data structure) and/or business rules for each customer's data set.

Next, the first subset of acquisition and retention costs may be processed to identify components of the channel-specific costs related to: (1) each data provider's loyalty or retention program; (2) commission costs paid out after the guest stay is consummated; (3) commission costs incurred by the hotel but paid directly to the vendor by the customer; (4) channel transaction fees associated with the cost of labor or technology to deliver a reservation; and/or (5) amenity or other acquisition or retention costs incurred as an incentive to encourage the customer make a booking at a given hotel. This may be performed using a combination of codes identifying costs types (specified by the common data structure) and/or business rules for each customer's data set.

The acquisition and retention costs of all transactions for a given time period are then aggregated or a per-channel basis to determine the total acquisition and retention cost for each discrete marketing channel.

Next, a contribution to operating expenses and profit (“COPE”) is determined by deducting all channel-specific costs by channel for any given time period from the total revenue for that channel (and/or from the room revenue for that channel) for the same time period. This provides a type of net revenue calculation—namely, room revenue or total revenue minus channel-specific acquisition and retention costs.

Corresponding data may then be displayed via a graphical user interface window to allow the user to display the total revenue (or the room revenue) and in the same view to see each of the individual channel-specific acquisition and retention costs for the same selected time period to identify the COPE % by channel and then the aggregate of all revenue and costs for all channels combined (composite COPE %). In the same window, the user can choose to filter this view of the data by many booking profile or customer profile variables in this GUI to view the variable by day of week, for particular market segments, by booking lead time, by length of stay, by rate codes or many other options based on codes available in the data set to help the user understand how the hotel is performing by many different perspectives.

Further, the analysis may include further identifying a second subset of the acquisition and retention costs, namely, a subset including sales and marketing costs that are associated generally across a plurality of marketing channels and not clearly associated with any specific transaction, and thus do not vary by marketing channel. Costs of all non-transaction-specific sales and marketing costs for each given time period are then aggregated to obtain a total. Corresponding total revenue and room revenue for the same time period that is recorded on the hotel's P&L is then identified and stored. The corresponding total revenue and room revenue for the same time period is then identified, and any channel-specific acquisition and retention costs are deducted from the revenue to get a net revenue value (revenue net of channel specific acquisition and retention costs). The corresponding total revenue and room revenue for the same time period is then identified and is grossed up by adding the channel-specific acquisition and retention costs that are paid directly to a vendor by the customer to generate a gross revenue value. These three revenue values (Gross Revenue, P&L Revenue and Net Revenue) are then each separately divided by the aggregate of all non-transaction-specific sales and marketing costs for each given time period to establish a three corresponding Sales and Marketing Efficiency values. This Sales and Marketing Efficiency value reflects revenue generated for every $1 spent in Sales and Marketing shown three ways: as P&L Revenue, Gross Revenue and Net Revenue.

The same metrics may also be calculated for the aggregate of all hotels in the subject hotel's competitive set (e.g., 5-8 hotels identified as a hotel's primary competitors) and for the aggregate of all hotels in the subject hotel's price range category in the same defined geographic area known as a metro area. For comparative purposes, a GUI window may be used to display the Sales and Marketing Efficiency by viewing it relative to Gross, P&L and Net Revenue and to choose to filter it by many variables such as booking profile or customer profile in this GUI to view the variable by day of week, for particular market segments, by booking lead time, by length of stay, by rate codes or many other options based on codes available in the data set to help the user understand how the hotel is performing by many different perspectives.

Further analysis involves dividing Gross Revenue by the number of available rooms in a subject hotel and doing the same for each of the hotels in the subject hotel's competitive set to derive a Gross RevPAR (Gross Revenue divided by number of available rooms) for each hotel.

For blind benchmarking purposes, the average Gross revPAR of the comp set may be set at 100 to calculate what percentage the subject hotel and all members of the comp set are against the average value set at 100, to provided indexed values. This Gross RevPAR index value is assigned to the subject hotel and each member of the comp set and stored.

Further analysis may be performed by dividing the P&L Revenue by the number of available rooms in a subject hotel and doing the same for each of the hotels in the subject hotel's competitive set to derive a P&L RevPAR (P&L Revenue divided by number of available rooms) for each hotel.

For blind benchmarking purposes, the average P&L Revenue of the comp set may be set at 100 to calculate what percentage the subject hotel and all members of the comp set are against the average value set at 100. This P&L Revenue index value is assigned to the subject hotel and each member of the comp set and stored.

Net Revenue, or “net res” (meaning, net of reservation costs) may be calculated as P&L Revenue minus channel-specific transaction fees, divided by the number of available rooms in a subject hotel and doing the same for each of the hotels in the subject hotel's competitive set to derive a Net RevPAR (Net Revenue divided by number of available rooms) for each hotel.

For blind benchmarking purposes, the average Net Res revPAR of the comp set may be set at 100 to calculate what percentage the subject hotel and all members of the comp set are against the average value set at 100. This Net Res RevPAR index value is assigned to the subject hotel and each member of the comp set and stored.

Next, the analysis may involve taking the Net Revenue−“net bacq”[net of total business acquisition costs] (P&L Revenue minus channel-specific transaction fees and sales and marketing costs that are associated generally (do not vary) across a plurality of marketing channels and not clearly associated with any specific transaction), and dividing Net Revenue−Net Bacq by the number of available rooms in a subject hotel and doing the same for each of the hotels in the subject hotel's competitive set to derive a Net RevPAR−net bacq (Net Revenue net of both channel-specific transaction costs plus all sales and marketing expenses, divided by number of available rooms) for each hotel.

For blind benchmarking purposes, the average Net Bacq revPAR of the comp may be set at 100 to calculate what percentage the subject hotel and all members of the comp set are against the average value set at 100. This Net Res Net Bacq index value is assigned to the subject hotel and each member of the comp set and stored.

A GUI window may be provided to allow the user to display the RevPAR metrics by viewing it relative to Gross, P&L, Net Revenue net of reservation costs and Net Revenue net of reservation costs plus all diffused sales and marketing expenses, and to choose to filter it by using variables such as booking profile or customer profile to view the variable by day of week, for particular market segments, by booking lead time, by length of stay, by rate codes or many other options based on codes available in the data set to help the user understand how the hotel is performing by many different perspectives.

Next, Net Revenue (net of channel-specific and all aggregated sales/marketing costs) is subtracted from the Gross Revenue and that result is divided by the number of a hotel's available rooms to derive the percentage that remains which is the RevPAR Capture. Its Gross revPAR (gross revenue per available room paid by customers) minus net revPAR [net Bacq] (revenue per available room after channel-specific acquisition and retention costs and all sales and marketing costs are removed) leaving the RevPAR Capture or the net revenue per available room. This net revenue per available room represents the funds available to the hotel to pay operating expenses and leave a profit.

In addition to these metrics, other data points may be used, such as derived data fields including length of stay—(departure date minus arrival date), booking lead time (arrival date minus booking date), arrival and departure days of week (the hotel systems usually have a date, not a day of week) and “flags” in the original data feed (such as whether it is a package purchase—as opposed to a room only—or if the guest is a loyalty club member) as filters for the resulting system metrics. Some data fields are the subject of reports, being the featured metric shown, and others are filters for the featured metric that will alter the outcome to include or exclude elements of the database, and many data fields can serve as both subject and filter.

When the performance metrics are calculated, they may reflect actual performance for the hotel by a variety of calculated variables such as business production (by room nights, revenue and average rate) by channel, sub-channel, segment, sub-segment, travel agency or other type of booker, and a total hotel aggregate of business production (using overall aggregate metrics such as revenue per available room, such as revPAR, hotel-wide occupancy %, hotel-wide average daily rate).

The DPS system 900 may also generate actual revenue showing only the total revenue received by the hotel or room revenue only, revenue that is net of booking costs, and revenue that is “grossed up” to represent the rate paid by the customer to a third party wholesaler who is given a net rate by the hotel, and marks it up and then keeps the markup as a commission. The actual amount the guest paid (to a third party) is not recorded (or known) by a hotel, but the Kalibri system uses the known commission cost that was deducted before arrival by the third party vendor and grosses up the revenue to reflect that amount so it is comparable to the business from other sources which contains the reservation costs meaning commissions and transaction fees. The system calculates the booking costs including the amount deducted before arrival from those booking through the third party vendors that use this “net rate” model, along with the booking commission and fee amounts that are paid after arrival for the bookings that come through all other vendors and direct to the hotel. The revenue net of booking costs is called the “COPE %” or contribution to profit and operating expense %.

It should be noted that herein, the terms “booking costs,” “reservation costs,” “res costs” and “commissions and transaction fees” are used interchangeably to refer to the channel-specific costs. Further, “sales & marketing costs” are the diffused costs that are not specific to any particular marketing channel, but rather are diffused over many channels. “acquisition and retention costs” or “business acquisition costs” are used herein to mean the sum total of all channel-specific costs plus those costs that are diffused over many channels for the total pool of funds used by a hotel to acquire and retain customers.

In this example, the “actual” performance figures are those actually experienced by the hotel, based on historical activity. It should be noted that the system may be configured to display as the “actual” performance, “actual” figures reflecting amounts routinely reported in a profit-and-loss (P&L) statement, or “net” figures reflecting amounts net of booking costs, or “gross” figures reflecting amounts grossed up to reflect the revenue if the pre-paid commission for the net-rated business of the hotel were included. Calculations may be system generated such as a sales and marketing efficiency metric that indicates the revenue generated for every dollar spent in sales and marketing. By combining the revenue figures with the externally appended sales and marketing expense, it is possible to derive this set of metrics.

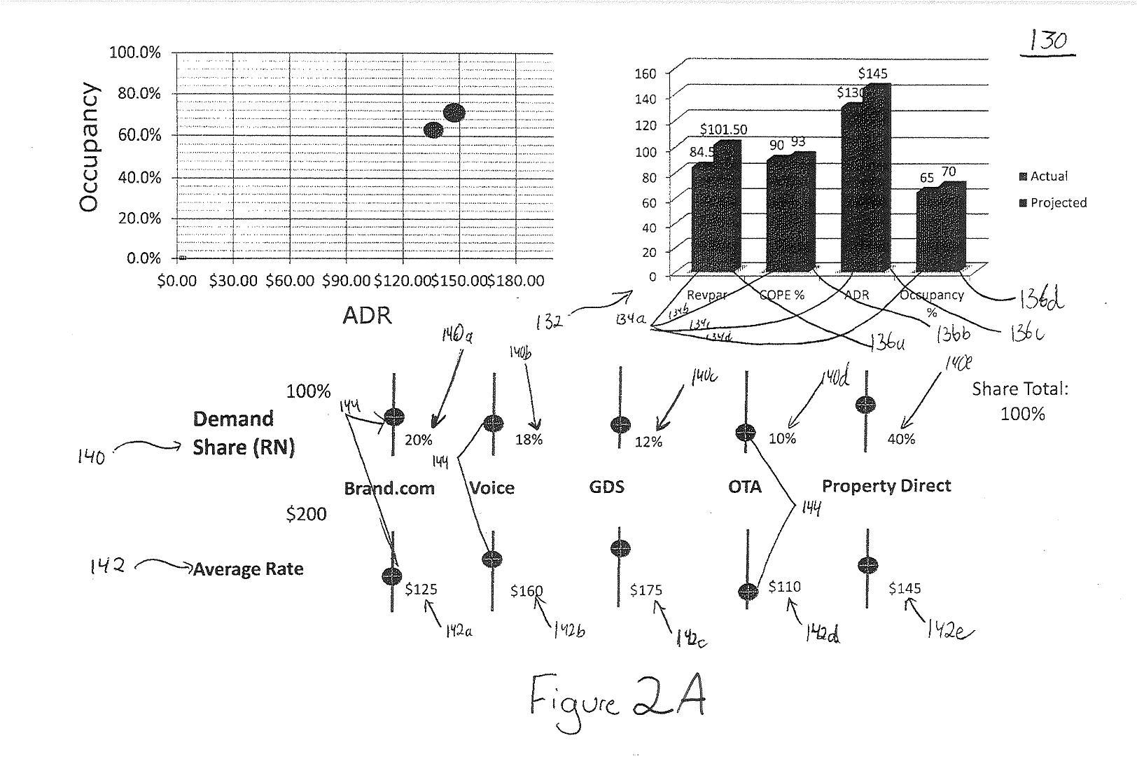

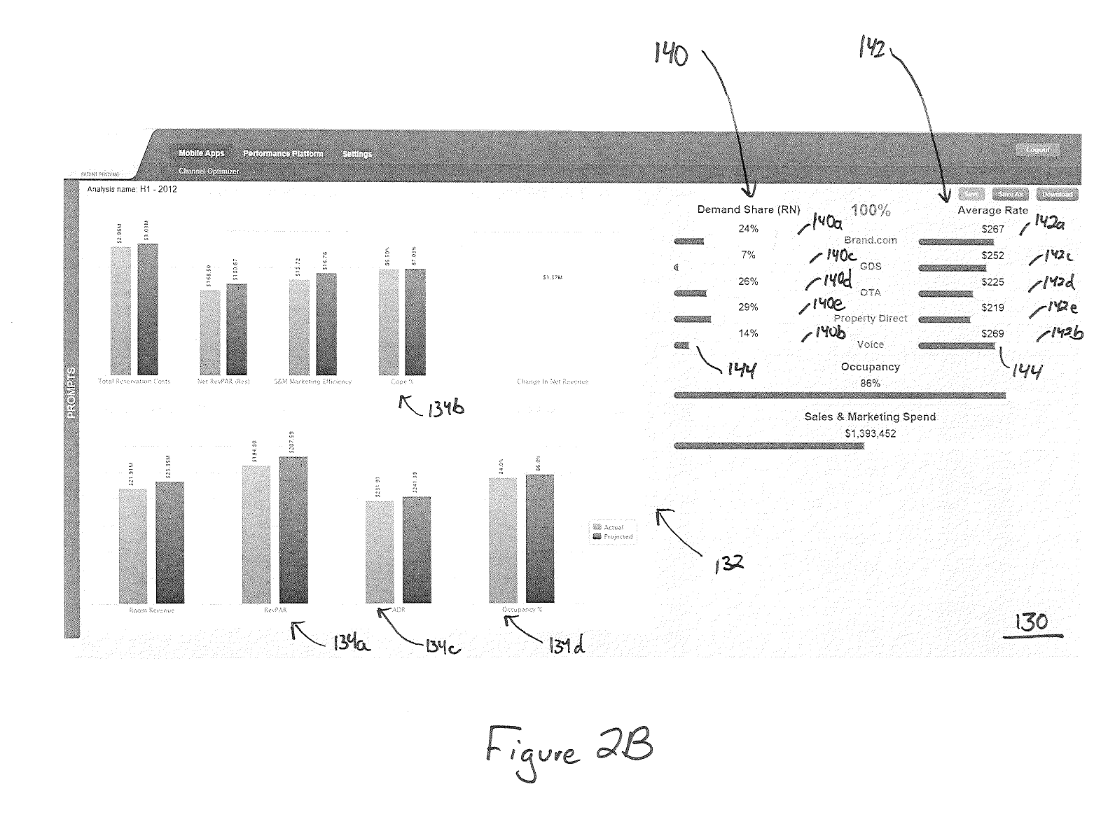

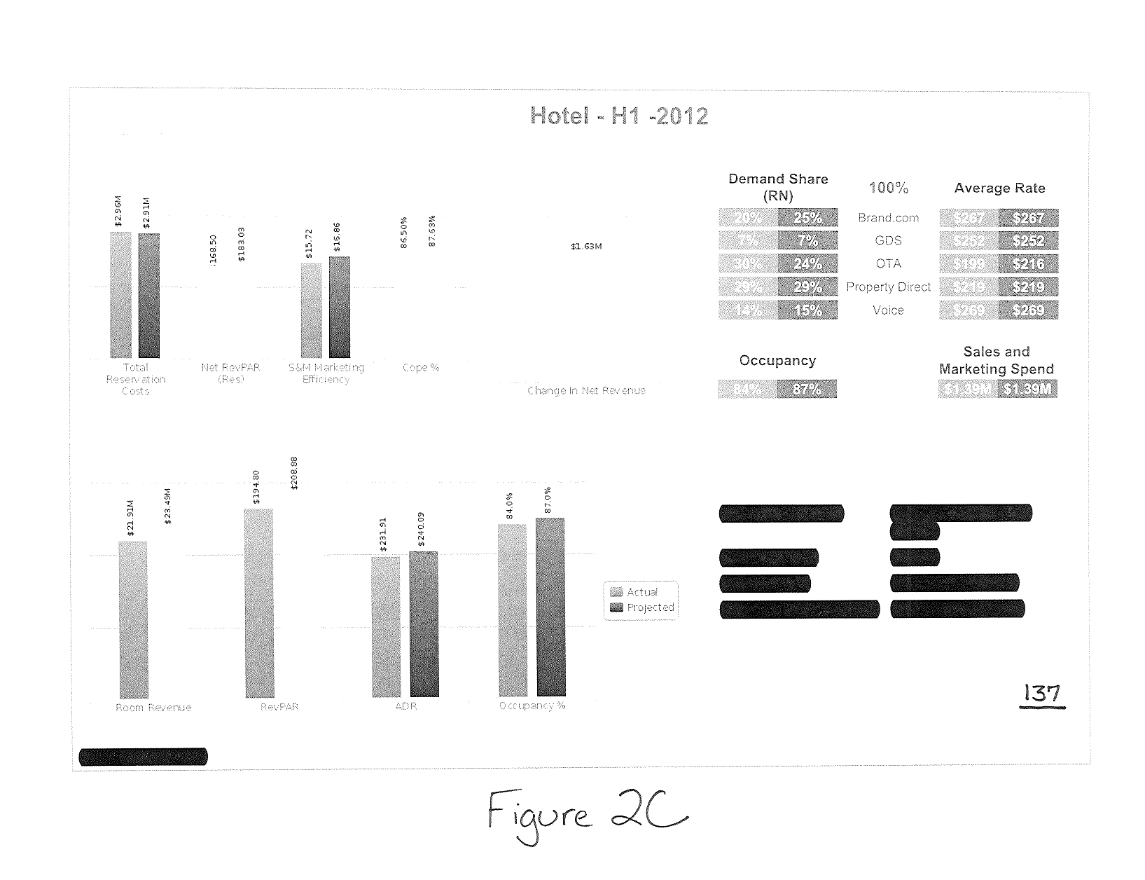

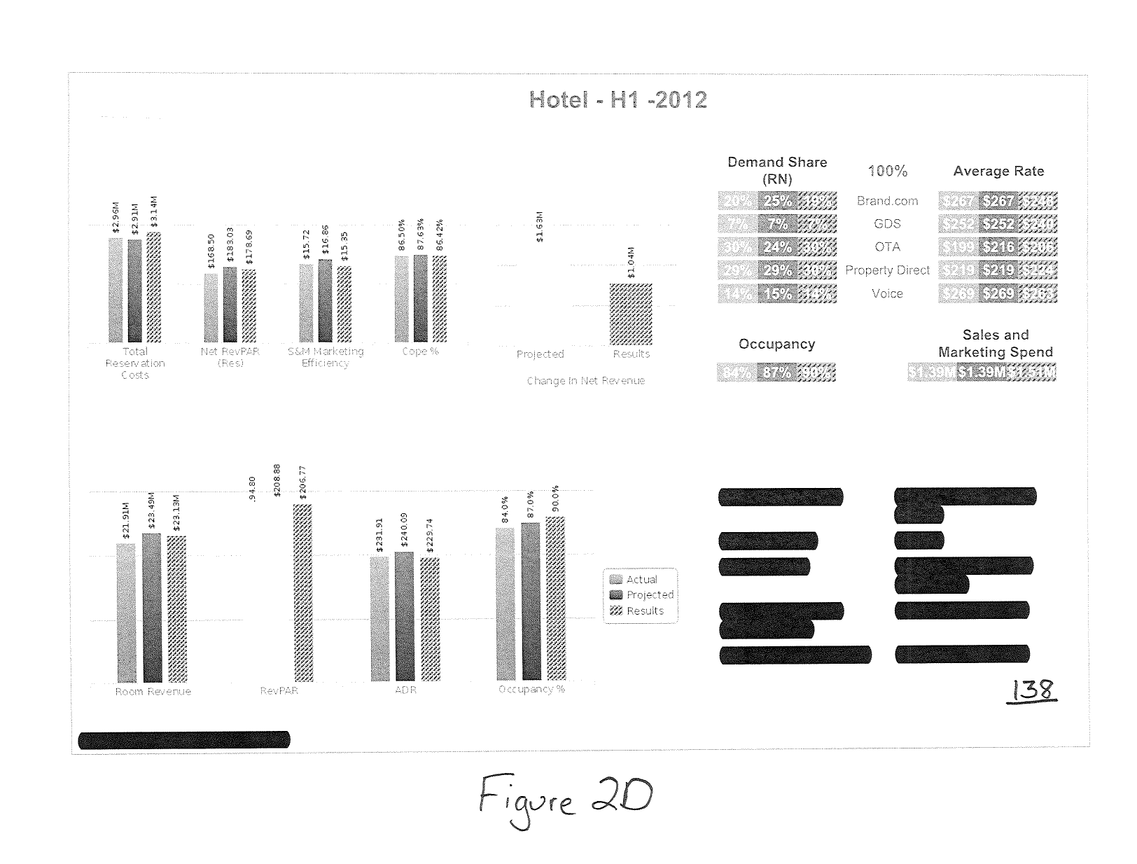

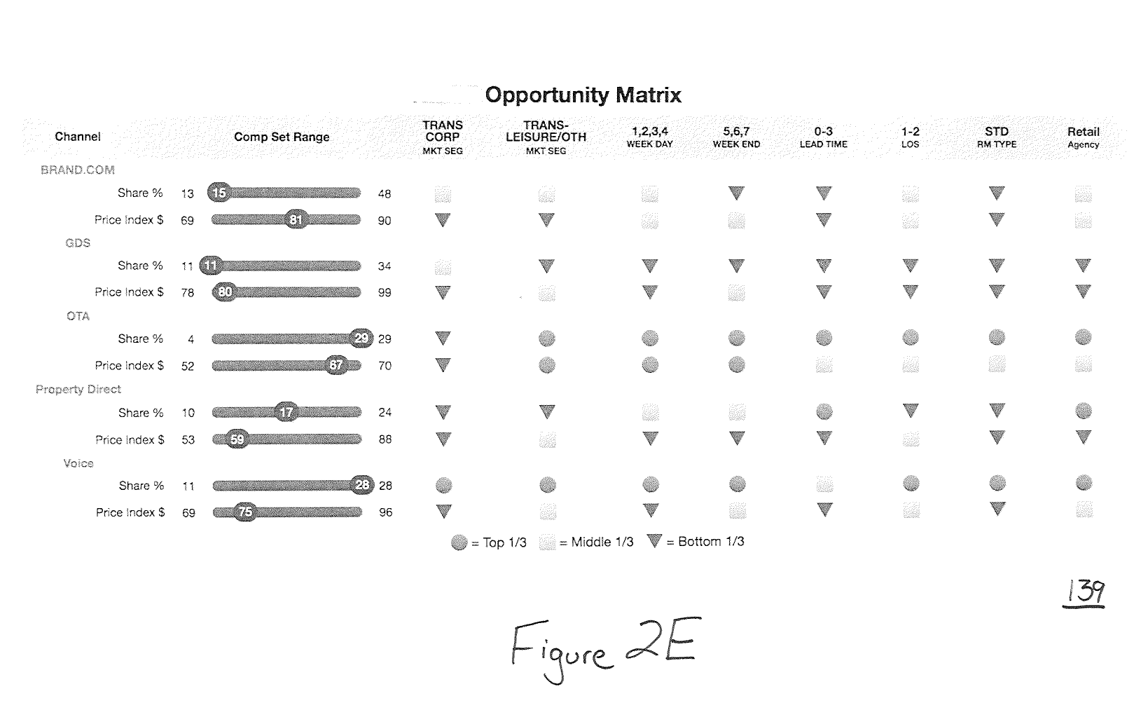

As discussed above, after making such calculations, the results are available for display to show a hotel's performance. Referring again to FIG. 1, the exemplary method next involves display in a graphical user interface window, e.g., displayed via a display device of the DPS 900, a representation of the calculated actual performance metrics, as shown at step 110. FIG. 2A shows an exemplary user interface window 130 showing a representation 132 of actual RevPAR, COPE %, ADR and Occupancy % performance metrics 134a, 134b, 134c, 134d. FIG. 2B shows an alternative exemplary user interface window 130 showing a representation 132 of actual RevPAR, COPE %, ADR and Occupancy % performance metrics 134a, 134b, 134c, 134d.

The method further involves display in the user interface window a list of the business mix metrics, as shown at 112. In this example, the business mix components Demand Share % (by channel) and Average Daily Rate (by channel) are the relevant business mix components 140, 144 shown in the user interface window 130 of FIGS. 2A and 2B.

Referring now to FIGS. 2A and 2B, the method further involves display of an actual value for each of the business mix components 140, 144, as shown at step 114. In this example, values 140a-140e, 142a-142e are shown for each of 5 different brand channels, namely, brand.com (representing sales made via a hotel's own website channel), voice (representing sales made by telephone to a central franchisor call facility), GDS (representing sales made via the systems used by a conventional travel agency), OTA (representing sales made via an online travel agency partner, such as Expedia, Travelocity, etc.), and property direct (representing sales may via telephone or in-person at a specific hotel property).

The method further involves display in the user interface window 130 a plurality of user-manipulable user interface controls for modifying values of the business mix components, as shown at step 116. In this example shown in FIGS. 2A and 2B, each control has the form of a slider or lever shown movable within a range bar. However, any suitable control may be used. In this example, a slider/lever 144 is shown for each of the 5 different channels of distribution.

The method then involves receiving input changing an actual value shown to a projected value for at least one of the business mix components to define projected business mix components, as shown at step 118. In the example of FIG. 2B, the actual business mix components are 24% brand.com demand share at an average daily rate of $267, 14% voice demand share at a daily rate of $269, 7% GDS at $252, etc. For example, the brand.com demand share could be increased from 24% to 25% and/or, the OTA demand share could be decreased from 30% to 24% while the voice demand share is increased from 14% to 15% by manipulating the sliders 144 in window 130 of FIG. 2B. This user interface window may be referred to as a “channel optimizer,” which provides information on a per-channel basis, and permits the providing of input allow for performance of “what if” scenarios to improve performance. This input may be provided by a user, e.g., using a mouse or touch-screen input device, to the DPS system 900.

Accordingly, aggregated business mix component data (e.g., RevPAR, ADR, COPE % and Occupancy %) is shown in numerical and graphical form in the left-most portion of the window 130, and disaggregated contributions to the aggregated data on a per-channel basis is shown via the user-manipulable controls (e.g., sliders) in the right-most portion of the window 130.

Next, in response to receipt of the user input, the DPS system 900 calculates projected performance metrics as a function of the projected business mix components, as shown at 120. Accordingly, this involves calculating the performance metrics using the changes input by the user. This may result in a change to one or more of the calculated actual performance metrics.

Next, the DPS 900 displays in the user interface window 130 a representation of the calculated performance metrics, as shown at step 122, and the exemplary method ends, as shown at 124. Accordingly, in the example of FIG. 2B, projected performance metric values 136a, 136b, 136c, 136d are shown in the representation 132 as projected values. These actual and projected values may be summarized in reporting window 137, as shown in FIG. 2C. Accordingly, in this step one or more of these actual values (representing historical data) may be varied to do “what-if” type scenario analysis, by changing a component and to see its projected impact on the broader performance metrics. Various combinations may be tried repeated in an effort to find changes that will improve or optimize performance.

Further, in the event that the proposed changes are adopted by the hotel, actual performance results resulting from the proposed changes may be reporting as well, e.g., as “results” values, as shown in results interface window 138 shown in FIG. 2D.

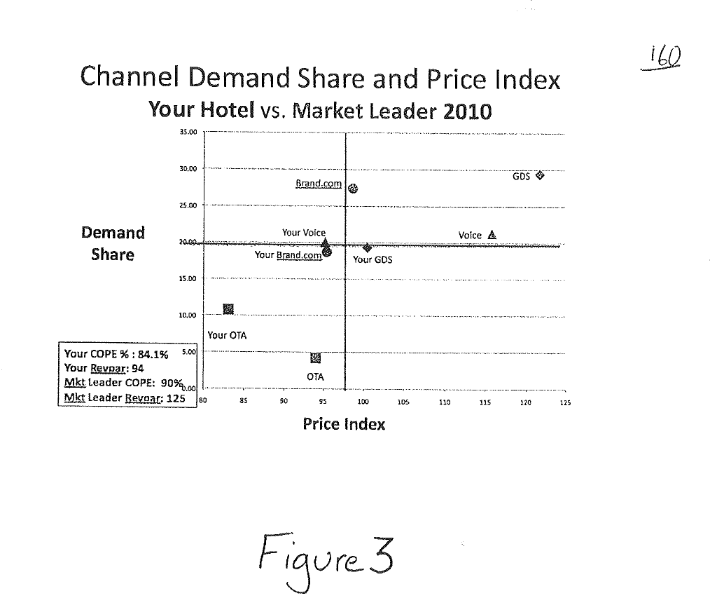

In certain embodiments, a subject hotel's performance may be displayed alongside the performance of one or more hotels according to the same metric(s), for benchmarking purposes. For example, the subject hotel's performance may be compared to a market leader, as shown in the exemplary graphical user interface window 160 of FIG. 3A. Alternatively, additional hotels may be identified that are comparable for comparative purposes, and similar performance metrics may be calculated for the hotels in the comparative subset (“comp set”), and performance metrics for the comp set may be displayed for benchmarking purposes. FIG. 2E shows a reporting user interface window 139 referred to herein as the opportunity matrix. As will be appreciated from FIG. 2E, the opportunity matrix displays information showing, or a given hotel, the relationship of its business mix components to others in its comp set, for informational and comparative purposes. For example, the exemplary window 139 shows that for the subject hotel for which the analysis has been performed, its demand share percentage for the brand.com marketing channel is 15%, and that the other hotels in the comp set (as known to the system) have demand share percentages for the brand.com marketing channel ranging from 13% to 48%, as indicated on the scale shown. Further, this relationship of the subject hotel's data to the comp set data is shown graphically, by the indicator positioned proportionally between the “13” and “48” endpoints. Accordingly, both a numerical and a graphical indication of the hotel/comp set comparison is provided. Further, a plurality of data segments are shown for further comparative purposes. For example, “week day” and “week end” segments are shown in FIG. 2E. The data segments to be shown may be selected by the system, or by the user, e.g., via another interface (not shown). The specific data segments available for selection is determined by the available data collected from the hotels, and the mappings to the normalized data structure. Here, the data is aggregated and segments so that the data is “sliced” and can be considered on a “week day” and “week end” basis, as well as on a per-channel basis. In the right-most portion of the opportunity matrix window 139, the subject hotel's opportunities are shown graphically, in coded form, for each segment shown. In this example, the following coding is used: a circle corresponds to the subject hotel's metric being in the top ⅓ of the comp set's data, a square corresponds to the subject hotel's metric being in the middle ⅓ of the comp set's data, and a triangle corresponds to the subject hotel's metric being in the bottom ⅓ of the comp set's data. Accordingly, for example, the opportunity matrix window 139 displays that the subject hotel's share % for the brand.com marketing channel is in the middle third (as shown by the square) for the “week day” segment, but is in the bottom third (as shown by the triangle) for the “week end” segment. Accordingly, this indicates that there is a relatively greater opportunity to improve the demand share percentage for the brand.com channel with respect to the weekend, rather than week day, bookings. Accordingly, aggregated share percentage data for the each channel is shown in numerical and graphical form in the left-most portion of the window 139, and disaggregated share percentage data for each channel is shown in coded form in the right-most portion of the window 139.

With respect to the opportunity matrix, a method is provided for analyzing hospitality industry data to parse a large data set and compare a subject hotel to its competitors. The method involves receiving from a plurality of hotels a plurality of transaction records. Each record comprises data arranged in fields. Each of the plurality of hotels' records comprises a unique set of fields consistent with a unique data structure. The method further includes processing the plurality of records to normalize the data to a common data structure standard, and calculating an actual performance value as a function of a plurality of business mix components by channel, e.g., as demand share and price index indicating what % of the room nights came through each channel, and as average rate identifying the average rate a hotel gets in each channel when indexed against a standard for the set of competitors that are being evaluated. The method further includes displaying a user interface window that allows a user to choose any variable that is a subset of the channel (such as booking profile or customer type, e.g., corporate segment, AAA customer, short lead time booker), and displays a representation of the actual performance value of a subject hotel in terms of a color code to indicate whether the subject hotel room night demand or average rate index falls in the top, middle or bottom one-third of the competitive set. For example, this may involve showing coding such that a top segment is indicated by green circle, a middle segment is indicated by a yellow square, and a bottom segment is indicated by a red triangle. The method further includes displaying in the user interface window a user-control for each of the current values of business mix components, each control being selectable to set as a column heading for evaluation within each channel, and saving in the user interface window a representation of the hotel's status for any given time for those selected parameters to compare between time periods.

FIG. 3 is an image of an alternative graphical user interface window 160 showing user interface controls for performing predictive analytics in accordance with an alternative embodiment of the present invention. In this example, the methodology is similar to that described above. However, the actual performance results and the actual values are displayed graphically, and the business mix components are displayed as symbols plotted on two axes of an x-y graph. In this embodiment, that symbols plotted on the graph are themselves the user-manipulable controls. Accordingly, what-if analysis may be performed by moving a symbol to provide a projected value, e.g., using a mouse, touch-screen or other user input device.

For example, when the user slides the brand.com symbol for the subject hotel (red circle), in a vertical upward or downward movement along the Y-axis, the demand share will increment to the value that corresponds to where the symbol is positioned. When the brand.com symbol for the subject hotel (red circle) is moved horizontally to the left or right, it will lower or raise the price index for the subject hotel to correspond to the value of the position to which it is moved. There is a cap on occupancy so the combined values of all the symbols representing the subject hotel on the Y-axis cannot exceed 100%. The market leader position represents competitors in the market who have the highest demand share or highest price index or highest blended performance for that particular channel. Each blue symbol represents the most demand (calculated as a % total room nights) or highest price index—these are the two options for market leader—for one competitor in the comp set. The blue symbols may each represent a different competitor. Once the subject hotel's channel symbols are moved to different positions to reflect the demand share and price index that is projected, the calculations for COPE %, RevPAR, occupancy and ADR will be recalculated to reflect the new projected position for the channel.

In accordance with another aspect of the present invention, a method for normalizing hospitality industry data transaction records is provided. FIG. 4 provides a flow diagram 200 in accordance with an exemplary embodiment of the present invention. By way of example, this method may be used to normalize data in conjunction with the method of FIG. 1.

Referring now to FIG. 4, the exemplary method begins with storing of a data structure standard identifying a reference code relevant to performance of a data analysis, as shown at step 202. The data structure standard may be stored in the memory of the DPS 900, as discussed below. The instance and structure of the standard may vary based on the desired level of granularity, the desired results of the analysis, etc.

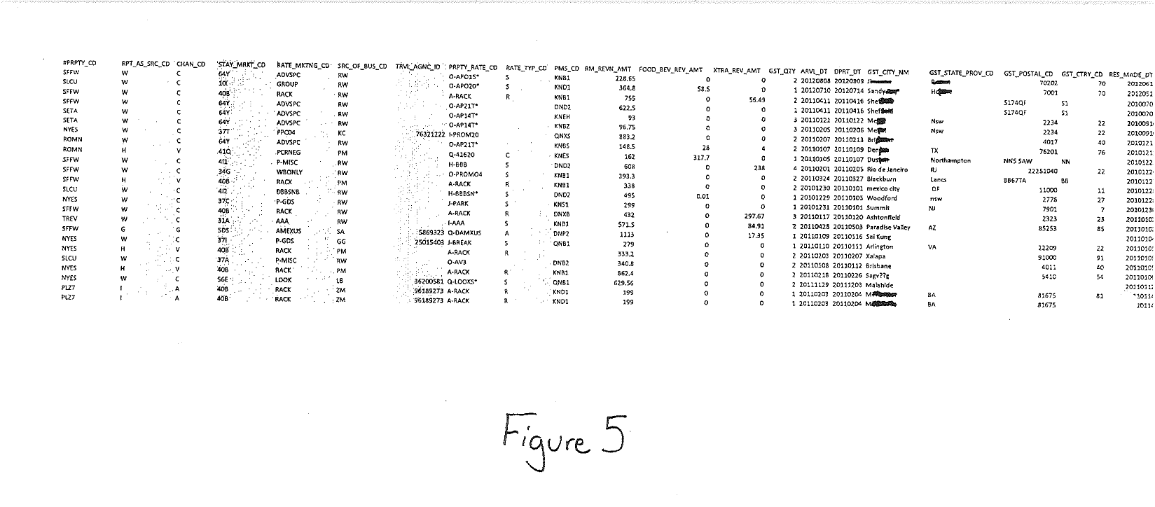

Next, the exemplary method involves identifying a plurality of records for a first hotel, as shown at step 204. As discussed above, in this context the records may be folio records, reservation records, or other transactions records. The records included data arranged in fields. An image of an exemplary representation of exemplary hospitality industry data including records having data arranged in fields is shown in FIG. 5.

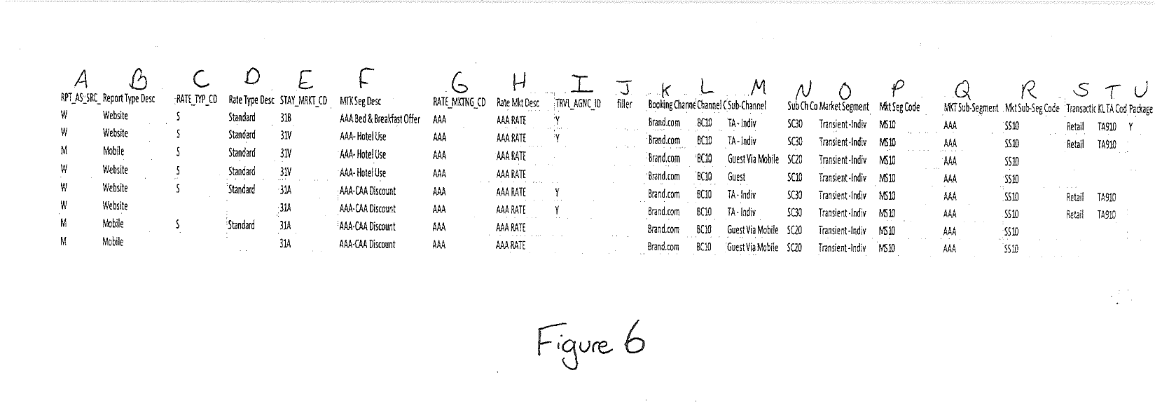

Next, a hotel-specific conversion table is retrieved, e.g., from the memory of the DPS, as shown at step 205. The conversion table identifies a mapping of unique combinations of data field values to corresponding codes of the data structure standard. Notably, the first time a set of transaction records is processed for a particular hotel, no conversion table may yet be stored, or the stored conversion table may be effectively empty. The conversion table may be built from scratch or augmented, as described herein. FIG. 6 is an image of a representation of a conversion table for normalizing in accordance with an exemplary embodiment of the present invention. The exemplary conversion table maps a unique combinations of data field values in columns A-I to the corresponding codes of the common data structure standard contained in columns K-U. The unique combinations of data fields values may be extracted from raw data contained in the records received from the hotels (e.g., the data records shown in FIG. 5). The corresponding codes of the data structure identified in columns K-U may be assigned to each unique combination in the first instance either manually, following review, consideration and categorization during a manual review process, or programmatically according to rules defined by the system. Any suitable method may be used for assigning the corresponding codes.

The hotel's records are then processed by the DPS to compare data field value combinations of a first record to the conversion table, as shown at step 208.

If it is determined that the combination of data field values being processed does not match a matching entry in the conversion table, then the data field value combination of the record being processed is added to a list of non-compliant combinations for further processing, as shown at steps 210 and 212, and the flow continues to processing of a next record of the plurality of records.

If, however, it is determined that the combination of data field values being processed does match a matching entry in the conversion table, then the data field value combination of the record is assigned the corresponding code(s) from the conversion table, as shown at steps 210 and 214. In other words, the common data structure codes associated with combination of data field values in the conversion table are added to the record (in a data store stored in the memory of the DPS 900) including the data field values.

It is next determined whether all of the first hotel's records have been processed, as shown at step 216. If not, flow continues to process the next record of the first hotel's records against the conversion table and the steps described above are repeated.

If it is determined in step 216 that all of the first hotel's records have been processed, then the method involves assigning corresponding codes from the data structure to each unique data field value combination in the list of non-compliant combinations, if any, as shown at step 218.

After the codes have been assigned to the new combinations, the conversion table is updated and stored in the memory of the DPS 900 for future use to process records, as shown at step 220. In this manner, the system “learns” over time to build the conversion table as hotels' records are processed. Again, the corresponding codes may be assigned manually during a manual review process or programmatically according to rules stored by the system. In this example, the method then involves processing the records including the non-compliant data field value combinations and assigning the corresponding code(s) to each record, as shown at step 222.

Next, the exemplary method involves determining whether all hotels' records have been processed, as shown in step 224. If not, the method begins to process records of a next hotel, and the steps described above with reference to steps 208-220 are repeated.

If, however, it is determined in step 224 that all hotels' records have been processed, then the method ends as shown at step 226.

It should be noted that this method is exemplary only, and that the entire method of FIG. 4 may be repeated after each receipt of a batch of records, e.g., on a daily basis.

It should be noted that the data from various hotels, across one or more franchises, have been normalized in this fashion, extensive data analysis can be performed not only on a per-hotel basis, but also among hotels across one or more franchises or brands, which is particularly valuable for benchmarking and/or other comparative or competitive analysis.

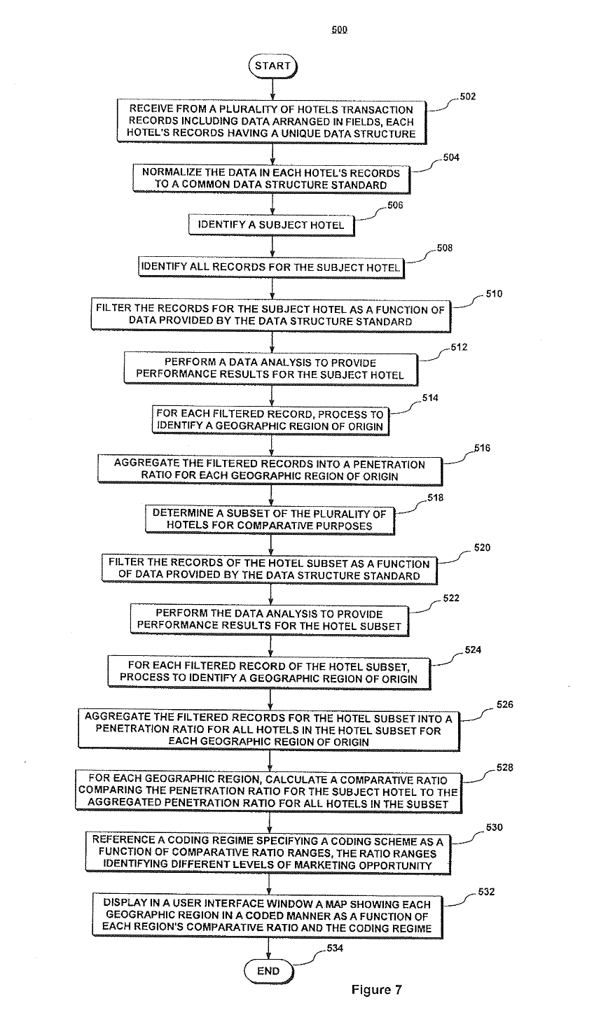

In accordance with another aspect of the present invention, a method for performing comparative analysis of hospitality industry data to identify marketing opportunities is also provided. FIG. 7 provides illustrative a flow diagram 500 in accordance with an exemplary embodiment of the present invention. This exemplary method allows for comparative analysis across multiple hotel brands having disparate data structures, and thus may be performed after completion of the data normalization processed described above with reference to FIG. 4. Referring now to FIG. 7, the exemplary comparative analysis begins with receipt from a plurality of hotels transactions records including data arranged in fields, as shown at step 502 and in a manner similar to that described above. The method next involves normalizing the data in each hotel's records to a common data structure standard, as shown at step 504, and as may be performed in a manner similar to that described above with reference to FIG. 4.

This exemplary method next involves identifying a subject hotel, e.g., a particular hotel for which an analysis will be performed, and then identifying the records corresponding to that subject hotel, as shown at steps 506 and 508.

Next, the subject hotel's records are filtered as a function of data provided by the data structure standard, as shown at step 510. For example, if the data structure identifies all commercial travel, or all group-rate travel, and it is desired to perform an analysis for all travel of this sort, then the filtering could be performed on one of these bases. For example, it may be desirable to evaluate a single hotel's leisure guest base using geographic mapping. The filters could be applied by selecting specific market segments or market sub-segments (reflected in the data structure standard) that apply to bookings from individual guests who stayed for a personal or leisure stay. It could be that the hotel would want to look at those bookings involving a package purchase for a room and breakfast, or a room and parking (vs. room only which is not a package). The hotel might also filter by removing those bookings for one night stays vs. 2 or more nights or those who booked two weeks before their stay or longer. Once these filters have been applied, the map will reflect only the bookings for those guests who fit the selected criteria.

Next, a data analysis is performed to provide performance results for the subject hotel, as shown at step 512. Any desired analysis, based on any desired filtering, may be performed consistent with the present invention. Notably, the performance analysis and comparisons can be made using the RevPAR metric, as discussed above.

In accordance with the present invention, for each filtered record in the analysis, the DPS system 900 processes the record to identify a geographic region of origin for the record, as shown at step 514. For example, this may involve identification of a zip code, county, or state of a residential address of a leisure traveler. The geography regions may be defined in any suitable manner, but a zip code breakdown within each county may be preferred since it makes it easier and more practical for the hotel to take marketing action on the findings by zip code to address through local or brand campaigns. The system may include pre-set parameters for every county in each major market that designates a list of zip codes for each county. Accordingly, after this step, the origin of each booking is attributable to a particular geographic region.

Next, the records of the filtered set are aggregated by geographic region to provide a penetration ratio by geographic region, as shown at step 516. For example, if the subject hotel has a count of 30 bookings in a particular zip code out of a total of 120 bookings for the relevant county, then the subject hotel has a hotel penetration ratio of 0.25.

The method further provides that a subset of the plurality of hotels is determined for comparative purposes, a shown at step 518. This may be performed by receiving manual input via the system, or may be performed in a programmatic fashion, e.g., by referencing rules or tables. One example of this would be selecting hotels from our database that are of a similar type such as “luxury” or “upper midscale.” These are typical types of property classifications which the system stores for each property. When a hotel operator wants to compare their property performance to that of their competitors, it is desirable to make the comparison to similar properties that charge similar rates and have similar guest amenities.

Generally, these steps are then repeated for the subset of hotels (the “comp set”). More specifically, the records of the comp set hotels are then filtered, a similar data analysis is then performed to provide performance results for the hotel subset in aggregate, each filtered record of the comp set is then processed to identify a geography region of origin, and the filtered records are aggregated into a total aggregated booking count for the comp set for each geographic region of origin, as shown at steps 520-526. For example, if the comp set as a whole has a count of 90 bookings in that zip code out of 900 bookings for the relevant county, then the comp set penetration ratio may be calculated as 0.1 for that region.

Next, for each geographic region of origin, a comparative ratio is calculated that compares the market penetration proportion for the subject hotel for each region (e.g., zip code) to the market penetration proportion that the comp set has for that zip code, as shown at step 528. For example, if the subject hotel has a hotel penetration ratio of 0.25 and the comp set has a penetration ratio of 0.1 for that region, then the subject hotel will have a comparative ratio of 2.5 (0.25 hotel ratio/0.1 comp set ratio) since it has produced 2.5 times the volume relative to the penetration of the overall comp set for that zip code. This indicates that the subject hotel in this case is over-indexing for that zip code and knows it has some advantages due to a stronger customer base than the other hotels in its comp set.

Next a coding legend is referenced that specifies a coding regime as a function of ratio ranges, as shown at step 530. Each of the comparative ratio ranges specifies one of a plurality of different levels of marketing opportunity. By way of example, the ranges may be predetermined values stored within the system as global default or system settings, or may be specified and/or stored on a hotel-specific or analysis-specific basis.

For example, the coding regime may provide that a region with a comparative ratio greater than 1.0 should result in red color-coding, that a region with a comparative ratio between 0.5 to 1.0 should result in gold color-coding, and that a region having a comparative ratio below 0.5 should result in light blue color coding, and further that regions with no business/calculated ratio at all for the comp set or the hotel should result in a gray color coding. It should be appreciated that any ranges and any coding regime can be used in accordance with the present invention.

Then, the method provides for the system's display in a user interface window each geographic region in a coded manner as a function of each region's calculated comparative ratio and the coding regime, as shown at step 532, and the method ends, as shown at 534.

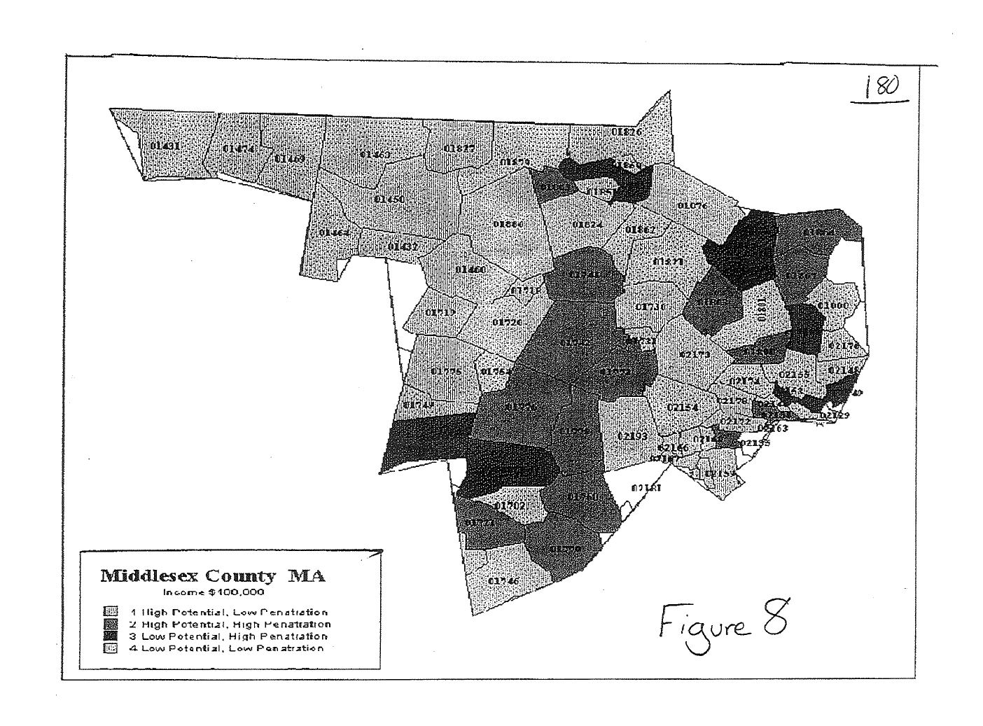

FIG. 8 is an image of an exemplary graphical user interface window 180 displaying a graphical representation of geography-based marketing opportunities in accordance with the method of FIG. 7. In this example, the red color will visually indicate that the hotel has a saturation or a high-level of market penetration and needs to be tested to determine if they have more potential or should just be maintained. The red zones are hot and have high penetration so could be tapped but are also areas where all the hotels in the comp set already compete. The gray and blue regions will visually indicate very low penetration and or the absence of a marketing/grown opportunity, because there is so little business that it is not worth a marketing investment.

In contrast, the gold areas indicate areas in which the hotel is under-indexing for business but where there is business worth competing for, and that the potential makes it worthwhile for the hotel to pursue the hard-to-find “golden nugget” of value in that geographical region. In this example, the golden regions have potential that the subject hotel has not tapped but its competitors have gotten above a pre-set threshold of business. These indices may be adjusted to reflect the density of business from any comp set into any particular market so they are auto-updated to reflect four tiers based on the market's volume.

Accordingly, this analysis can be used to identify marketing opportunities and inform growth and marketing decisions. More specifically, a hotel performing this analysis can leverage this intelligence to build marketing campaigns that can best match resources against regions with the highest likelihood of success. The map can also be generated at various levels of geography; it may be for one state with color coding representing each county in that state or it could be generated at a more granular level of geography than zip code, such as “block group” a census designation which is like a neighborhood (there are 200,000 block groups in the US each of which is approximately 39 blocks). If it is a zip code map showing block group, then the entire map may be for only one zip code with small block groups color-coded within that zip code to reflect business penetration indexed by subject hotel against the comp set totals. The example of FIG. 8 is shown for Middlesex County (Boston) with zip codes within that county. The decision about the granularity of the geography and the thresholds set for color-coding is customized based on the population density of each market to provide meaningful intelligence for the hotel to undertake sales efforts into those markets.

Following the normalization of data described herein, and in accordance with a robust common data structured, the maps can be created by filtering with a high degree of granularity, e.g., to filter by package type, length of stay and lead time.

FIG. 9 is a schematic diagram showing an exemplary data processing system (DPS) 900 in accordance with an exemplary embodiment of the present invention. The DPS 900 includes conventional hardware storing specially-configured computer software for carrying out a method in accordance with the present invention. It should be noted that the DPS 900 may be configured as any suitable type of computing device in any suitable computing environment, and thus for example may be configured as a server, a client device, a cloud-computing terminal, or a stand-alone workstation.

For illustrative purposes, the exemplary DPS 900 of FIG. 9 includes a general purpose microprocessor (CPU) 902 and a bus 904 employed to connect and enable communication between the microprocessor 902 and the components of the DRAS 900 in accordance with known techniques. The exemplary DPS 900 includes a user interface adapter 906, which connects the microprocessor 902 via the bus 904 to one or more interface devices, such as a keyboard 908, mouse 910, and/or other interface devices 912, which can be any user interface device, such as a touch sensitive screen, digitized entry pad, etc. The bus 904 also connects a display device 914, such as an LCD screen or monitor, to the microprocessor 902 via a display adapter 916. The bus 904 also connects the microprocessor 902 to memory 918, which can include a hard drive, diskette drive, tape drive, etc.

The DPS 900 may communicate with other computers or networks of computers, for example via a communications channel, network card or modem 922. The DPS 900 may be associated with such other computers in a local area network (LAN) or a wide area network (WAN), and/or may operate as a server in a client/server arrangement with another computer, as a computing device in a cloud-computing environment, etc. Such configurations, as well as the appropriate communications hardware and software, are known in the art.

The DPS's software is specially configured in accordance with the present invention. Accordingly, as shown in FIG. 9, the DPS 900 includes instructions stored in the memory for causing the DPS to carry out the methods described herein. Further, the memory stores certain data, e.g. in databases or other data stores shown logically in FIG. 9 for illustrative purposes, without regard to any particular embodiment in one or more hardware or software components. For example, FIG. 9 shows schematically storage in the memory 918 of instructions implementing an analytical engine for carrying out the methods described herein, a data structure standard, performance metric definitions/equations, business mix component definitions, raw hotel records, normalized hotel records, actual performance values, projected performance values, a conversion table, a list of non-compliant combinations of field values, comparative ratios, and coding regime data.

Additionally, computer readable media storing computer readable code for carrying out the method steps identified above is provided. The computer readable media stores code for carrying out subprocesses for carrying out the methods described above.

A computer program product recorded on a computer readable medium for carrying out the method steps identified above is provided. The computer program product comprises computer readable means for carrying out the methods described above.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for analyzing hospitality industry data using a computerized system comprising a processor operatively connected to a memory storing instructions for controlling the processor to perform predictive analysis comprising:
receiving from a plurality of hotels a plurality of transaction records, each record comprising data arranged in fields, each of said plurality of hotels' records comprising a unique set of fields consistent with a unique data structure;
processing said plurality of records to normalize the data to a common data structure standard;
calculating an actual performance value as a function of a plurality of business mix components;
displaying in a user interface window a representation of the actual performance value;
displaying in the user interface window an identification of each of the plurality of business mix components, and a current value for each of the plurality of business mix components;
displaying in the user interface window a user-manipulable control for each of the current values of the plurality of business mix components, each control being adjustable to receive input from a user changing a current value to a projected value;
receiving input adjusting at least one current value to a corresponding projected value to define projected business mix components including the projected value;
calculating a projected performance value as a function of the projected business mix components; and
displaying in the user interface window a representation of the projected performance value.

2. The method of claim 1, wherein calculating an actual performance value or a projected performance value as a function of the projected business mix components comprises:
for each channel of the plurality of marketing channels, identifying a first subset of acquisition and retention costs, each cost of the first subset being associated specifically with each corresponding channel because each cost is charged in direct connection with a specific transaction through the specifically identifiable marketing channel.

3. The method of claim 2, wherein calculating an actual performance value or a projected performance value as a function of the projected business mix components comprises:
processing the first subset of acquisition and retention costs to identify components of the channel-specific costs.

4. The method of claim 1, wherein calculating an actual performance value or a projected performance value as a function of the projected business mix components comprises:
aggregating acquisition and retention costs of all transactions for a given time period on a per-channel basis to determine total acquisition and retention cost for each of the plurality of marketing channels.

5. The method of claim 2, wherein calculating an actual performance value or a projected performance value as a function of the projected business mix components comprises:
for each channel of the plurality of marketing channels, calculating a contribution to operating expenses and profit (COPE) by deducting all channel-specific costs for any given time period from revenue for that channel for the same time period.

6. The method of claim 2, wherein calculating an actual performance value or a projected performance value as a function of the projected business mix components comprises:
for each channel of the plurality of marketing channels, identifying a second subset of acquisition and retention costs, each cost of the second subset being associated generally across the plurality of marketing channels and not clearly associated with any specific marketing channel.

7. The method of claim 6, wherein calculating an actual performance value or a projected performance value as a function of the projected business mix components comprises:
aggregating costs of the second subset for a given time period;
determining total revenue for the same time period as recorded via the subject hotel's profit and loss records;
determining room revenue for the same time period as recorded via the subject hotel's profit and loss records;
deducting costs of the first subset from the total revenue value to determine a net revenue value.
calculating a gross total revenue value by adding to the total revenue value costs of the first subset;
calculating a gross room revenue value by adding to the total revenue value costs of the first subset;
summing the net revenue value, gross total revenue value, and gross room revenue value; and
dividing the sum by the second subset of costs for the given time period to calculate a Sales and Marketing Efficiency value.

8. The method of claim 7, further comprising calculating an actual performance value or a projected performance value for each hotel of a plurality of hotels in a set.

9. The method of claim 8, further comprising calculating an actual performance value or a projected performance value for all hotels of a plurality of hotels in a set, taken in aggregate.

10. The method of claim 9, wherein displaying in the user interface window a representation of the projected performance value comprises:
displaying the Sales and Marketing Efficiency by value in the window;
displaying the Gross Revenue value in the window;
displaying a P&L Revenue value in the window, the P&L Revenue value reflect hotel revenue as represented on in the profit and loss (P&L) records of the hotel; and
displaying the Net Revenue value in the window.

11. The method of claim 10, wherein calculating an actual performance value or a projected performance value as a function of the projected business mix components comprises:
dividing the subject hotel's Gross Revenue value by a number of available rooms in the subject hotel to derive a corresponding Gross RevPAR for the subject hotel;
for each hotel in a set of hotels, dividing each hotel's Gross Revenue value by a number of available rooms for each corresponding hotel to derive a corresponding Gross RevPAR for each corresponding hotel;
determining an average Gross revPAR for all hotels in the set; and
setting the average Gross revPAR to an index value and calculating a corresponding index value for the subject hotel as a percentage of the index value.

12. The method of claim 11, wherein calculating an actual performance value or a projected performance value as a function of the projected business mix components comprises:
dividing the subject hotel's P&L Revenue by the number of available rooms in a subject hotel and the hotels in the subject hotel's competitive set to derive a P&L Revenue for the subject hotel;
for each hotel in the set of hotels, dividing each hotel's P&L Revenue value by a number of available rooms for each corresponding hotel to derive a corresponding P&L Revenue for each corresponding hotel;
determining an average P&L Revenue for all hotels in the set; and
setting the average P&L Revenue to an index value and calculating a corresponding index value for the subject hotel as a percentage of the index value.

13. The method of claim 12, wherein calculating an actual performance value or a projected performance value as a function of the projected business mix components comprises:
for the subject hotel, calculating Net Revenue as P&L Revenue minus the first subset of costs, divided by the number of available rooms in the subject hotel and the hotels in the subject hotel's competitive set to derive a Net RevPAR
for each hotel in the set, calculating Net Revenue as P&L Revenue minus the first subset of costs for each hotel, divided by the number of available rooms in each hotel in the set to derive a Net RevPAR;
determining an average Net Res revPAR for all hotels in the set; and
setting the average Net Res revPAR to an index value and calculating a corresponding index value for the subject hotel as a percentage of the index value.

14. The method of claim 13, wherein calculating an actual performance value or a projected performance value as a function of the projected business mix components comprises:
for the subject hotel, calculating Net RevPAR−net bacq as P&L Revenue minus the first subset of costs minus the second subset of costs, and dividing by the number of available rooms in the subject hotel;
for each hotel in the set of hotels, calculating Net RevPAR−net bacq as P&L Revenue minus the first subset of costs for each corresponding hotel minus the second subset of costs for each corresponding hotel, and dividing by the number of available rooms in each corresponding hotel;
determining an average Net RevPAR−net bacq for all hotels in the set; and
setting the average Net RevPAR−net bacq to an index value and calculating a corresponding index value for the subject hotel as a percentage of the index value.

15. The method of claim 14, wherein calculating an actual performance value or a projected performance value as a function of the projected business mix components comprises:
for the subject hotel, calculating RevPAR capture as Gross RevPAR minus Net RevPAR (net Bacq).

16. The method of claim 15, wherein displaying in the user interface window a representation of the projected performance value comprises displaying in the user interface window the RevPAR capture value and the Net RevPAR value juxtaposed with Gross Revenue, P&L Revenue, Net Revenue net of reservation costs, and Net Revenue net of reservation costs plus all diffused sales and marketing expenses values.

17. A method for normalizing hospitality industry transaction data records using a computerized system comprising a processor operatively connected to a memory storing instructions for controlling the processor to perform analysis comprising:
identifying a plurality of transaction records including transaction data from a plurality of hotels, each of said plurality of hotels' records comprising a unique set of fields consistent with a unique data structure;
storing a data structure standard identifying a plurality of reference codes relevant to performance of a data analysis;
for each of said plurality of hotels,
processing a corresponding plurality of records to identify unique data field value combinations;
assigning to each record containing a unique data field value combination at least one corresponding code form said data structure standard;
storing in a conversion table each unique data field value combination in association with its at least one corresponding code; and
processing the corresponding plurality of records to assign to each record at least on corresponding code as a function of a respective data field combination contained in each record and the at least one corresponding code identified in the conversion table;
whereby the data of each record of each of said plurality of hotels is thereby normalized to include reference codes from the data structure standard.

18. A method for performing comparative analysis of hospitality industry data using a computerized system comprising a processor operatively connected to a memory storing instructions for controlling the processor to perform analysis comprising:
identifying a plurality of transaction records including transaction data from a plurality of hotels, each of said plurality of hotels' records comprising a unique set of fields consistent with a unique data structure;
processing said plurality of records to normalize the data to a common data structure standard, the data structure standard identifying a plurality of reference codes relevant to performance of a data analysis;
filter the records of a subject hotel as a function of at least one reference code to determine market penetration by geographical region;
identify a subset of the plurality of hotels for comparative purposes;
filter the records of the subset as a function of the at least one reference code to determine market penetration by geographical region;
process the filtered records of the subject hotel and the subset to determine a comparative ratio comparing marketing penetration of the subject hotel relative to market penetration of the hotels in the subset;
reference a coding regime specifying a coding scheme as a function of ratio ranges, each ratio range reflecting a respective one of a plurality of different levels of marketing opportunity; and
display via a graphical user interface a map showing a plurality of geographical regions coded as a function of each region's comparative ratio and the coding regime.

19. A method for analyzing hospitality industry data using a computerized system comprising a processor operatively connected to a memory storing instructions for controlling the processor to parse a large data set and compare a subject hotel to its competitors by:
receiving from a plurality of hotels a plurality of transaction records, each record comprising data arranged in fields, each of said plurality of hotels' records comprising a unique set of fields consistent with a unique data structure;
processing said plurality of records to normalize the data to a common data structure standard;
calculating an actual performance value as a function of a plurality of business mix components for each of a plurality of marketing channels corresponding to transactions reflected in the plurality of transaction records; and
displaying via a display of the system a user interface window allowing a user to choose a variable corresponding to at least one of the plurality of marketing channels, the window further displaying a representation of the actual performance value of a subject hotel coded fashion to indicate how the actual performance value compares to corresponding performance values of other hotels in a comparative set.

20. The method of claim 19, further comprising:
displaying in the user interface window a scale showing numerically the subject hotel's performance value relative to the high and low performance values of hotels in the set.

21. The method of claim 19, further comprising:
displaying in the user interface window a scale showing graphically the subject hotel's performance value relative to the high and low performance values of hotels in the set.

22. The method of claim 19, further comprising:
storing in the memory a representation of the hotel's status for a given time period to permit comparison among different time periods.

23. The method of claim 19, wherein one of said plurality of business mix components comprises a demand share metric indicating a percentage of room night transactions associated with a corresponding marketing channel.

24. The method of claim 19, wherein one of said plurality of business mix components comprises a price index metric indicating an average room rate associated with a corresponding marketing channel.

25. The method of claim 19, wherein the variable reflects a subset of each marketing channel, such as a booking profile or a customer type.

26. The method of claim 19, wherein the coded fashion comprises indications as to whether each actual performance values falls in a top, middle or bottom third of corresponding values for the set.

27. A method for analyzing hospitality industry data using a computerized system comprising a processor operatively connected to a memory storing instructions for controlling the processor to perform predictive analysis comprising:
receiving from a plurality of hotels a plurality of transaction records, each record comprising data arranged in fields, each of said plurality of hotels' records comprising a unique set of fields consistent with a unique data structure;
processing said plurality of records to normalize the data to a common data structure standard;
identifying a plurality of marketing channels for each booking contained in the plurality of transaction records;
calculating an aggregate revenue value reflecting aggregated revenue from all of said plurality of marketing channels;
calculating an aggregated cost value reflecting aggregated customer acquisition costs from all of said plurality of marketing channels;
identifying a first subset of customer acquisition costs, the first subset including customer acquisition costs that are associated generally across the plurality of marketing channels;
identifying a second subset of customer acquisition costs, the second subset including customer acquisition costs that are associated specifically with each channel of the plurality of marketing channels;
for each of the plurality of marketing channels, calculating a corresponding channel-specific net revenue value reflecting net revenue on a per-channel basis; and
displaying in a user interface window a representation of the calculated values, the calculated values reflecting actual performance.

28. The method of claim 27, further comprising:
displaying in the user interface window an identification of each of a plurality of business mix components, and a current value for each of the plurality of business mix components;
displaying in the user interface window a user-manipulable control for each of the current values of the plurality of business mix components, each control being adjustable to receive input from a user changing a current value to a projected value;
receiving input adjusting at least one current value to a corresponding projected value to define projected business mix components including the projected value;
calculating a projected performance value as a function of the projected business mix components; and
displaying in the user interface window a representation of the projected performance value.

29. The method of claim 27, further comprising:
calculating absolute metrics comprising:
a GrossRevPAR value reflecting aggregated a total of room revenue and other revenue on the basis of revenue per available room;
a Net RevPAR value reflecting gross revenues net of total acquisition and retention costs on the basis of revenue per available room;
a P&L RevPAR value reflecting revenue reflected in the hotel's P&L records on the basis of revenue per available room;
a Net RevPAR (net res) value reflecting channel-specific costs deducted from the P&L Revenue on the basis of revenue per available room; and
a Net RevPAR (net bacq) value reflecting channel-specific costs and all other sales and marketing expenses combined to represent the hotel's total acquisition and retention cost deduced from the hotel's P&L Revenue on the basis of revenue per available room; and
displaying the absolute metrics in the user interface window.

30. The method of claim 27, further comprising:
identifying sub-channels for each of said plurality of marketing channels, each sub-channel identifying with respect to each hotel transaction record one of: who made the booking; segments to indicate the trip purpose of the traveler; sub-segments to reflect the rate type paid by the traveler; and accounts that booked the business;
recalculating at least one of the absolute metrics for at least one sub-channel; and
displaying the at least one recalculated absolute metric in the user interface window.

31. The method of claim 27, further comprising:
identifying for each of said plurality of hotel transaction record a booking profile reflecting one of: lead time; length of stay; week days spanned by a stay; months spanned by a stay; room type; and package type;
recalculating at least one of the absolute metrics for at least one booking profile; and
displaying the at least one recalculated absolute metric in the user interface window.
